(19) United States
(12) Patent Application Publication
(10) Pub. No.: US 2016/0258417 A1
(43) Pub. Date: Sep. 8, 2016

(54) Stacked blade windmill

(71) Applicant: Joseph Chiang, Tolna, ND (US)

(72) Inventor: Joseph Chiang, Tolna, ND (US)

(21) Appl. No.: 14/756,629

(22) Filed: Aug. 27, 2015

Related U.S. Application Data
(63) Continuation of application No. 62/068,235, filed on Oct. 24, 2014.

(51) Int. Cl. F03D 7/02; F03D 1/06

(52) U.S. Cl. CPC F03D 7/0276; F03D 1/0633

(57) ABSTRACT

A windmill or watermill with a polarity of blades that are not uniformly spaced, but are placed in blade sets such that each blade set has blades behind and slightly offset from the one in front axially of the axis of rotation, I call “stacked Blades”. Each blade set is placed in balance with other blade sets around the central axis. There may be 2 or more blades in a stacked blade set and 2 or more blade sets in balance around the axis (FIG. 10). It is unique that “Stacked Blades” harnesses the turbulence or drag; I call “spill over” wind. In high wind applications, the blades are “Un-Stacked” starting by turning of the back blade 90° to the wind. As the wind increases, the next back blades are so turned and so forth until all blades are turned 90° to the wind (FIGS. 6, 7, 8, and 9). Please note; it is not possible to unstack blades that have not first been stacked. Each edge of the blade will become a narrow un-stacked blade in its own right (FIGS. 4 and 5). In windmill operation, when wind decreases below what is needed for best windmill operation, small jets or rockets fueled by methane gas will fire and maintain windmill operation (FIGS. 11 and 12) and maintain reasonably consistent rpms, even in low to zero wind.

Stacked Blades: This invention relates to windmills and watermills which rotate about a horizontal axis in alignment with the wind or fluid flow. Current windmills and watermills having multiple blades have normally, but not exclusively, been located in a single plane of rotation. Some have staggered their blades in the third dimension, but in a uniformly spaced relationship around the shaft, just in the third dimension. The front view still shows a two dimensional uniformly spaced blade orientation.

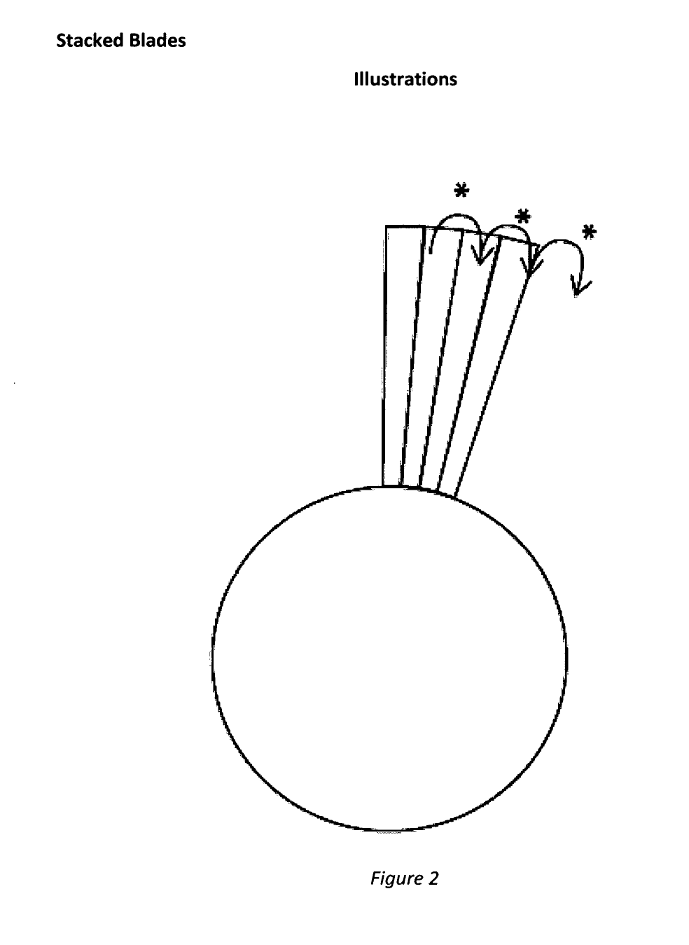

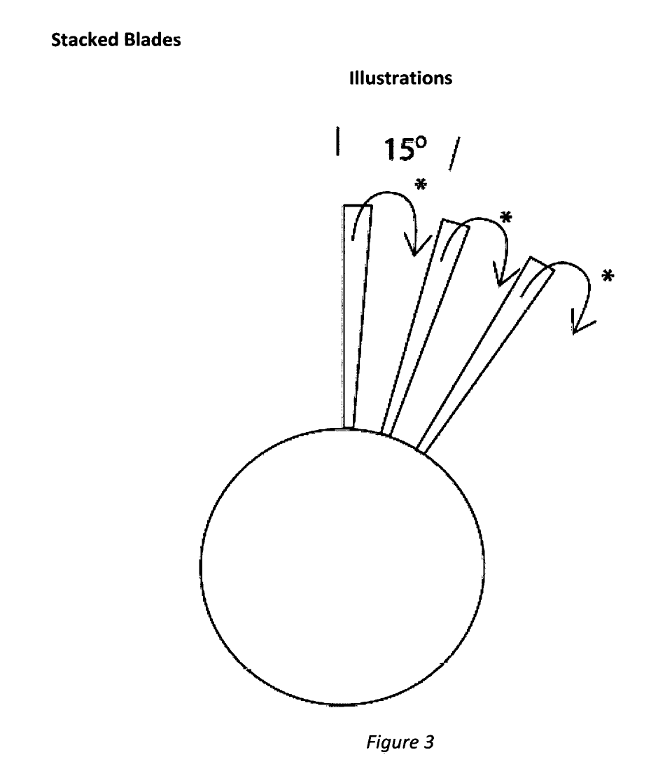

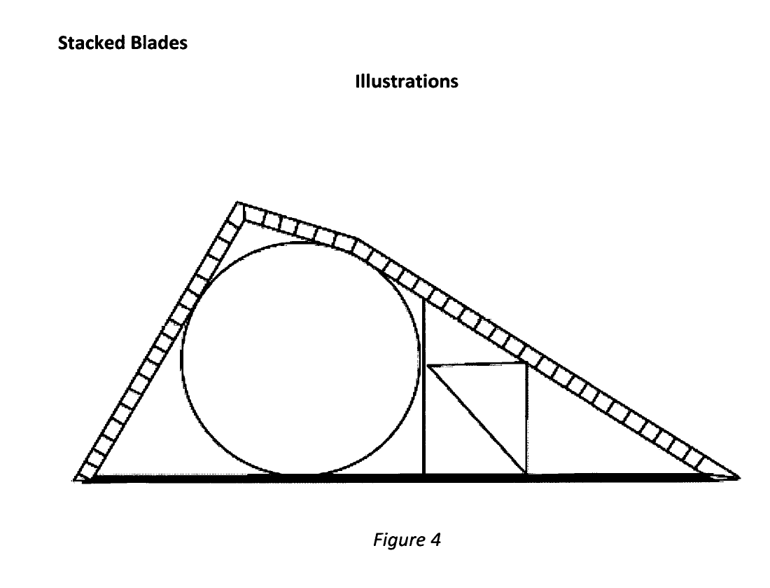

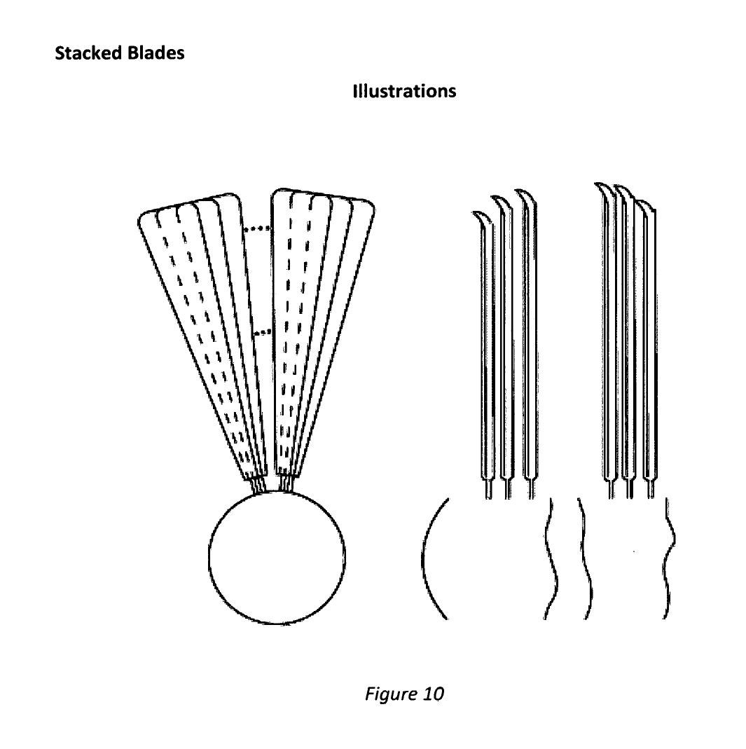

It is an object of this invention to have a plurality of blades (FIG. 2) such that one is behind the other and slightly offset in each blade set. The purpose is to capture the calculus of spillover of wind or fluid flow from the front blade to each of the blades behind it (FIG. 2). This spill over has traditionally been considered turbulence creating drag, something negative, but stacked blades harnesses this negative wind or fluid flow and converts it into additional electric power. The collection of the front blade and all the blades behind it I call a “bade set”. In the front view, a stacked blade set will have no space detected between the blades (FIG. 2). There has always been a space between blades with evenly distributed blades in the front view (FIG. 3). The result is the wind or fluid flow always spills off the front blade and passes between the evenly spaced blades with incidental or no spillover (FIG. 3). Very knowledgeable people have had difficulty understanding from words and even pictures/drawings the true nature of stacked blades. A “Stacked blade set” can be easily identified in all windmills by no space visible between blades in the front view (FIG. 4). All other windmills have in the front view just one blade followed by a space before the next blade, and always evenly spaced blades (FIG. 3). The stacked blade set may have a dozen or more blades in each blade set (FIG. 10).

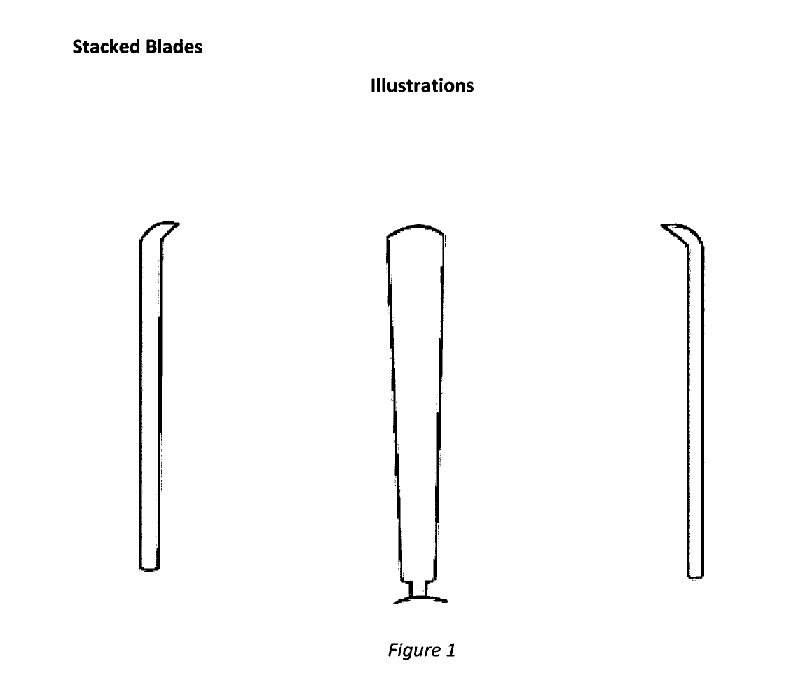

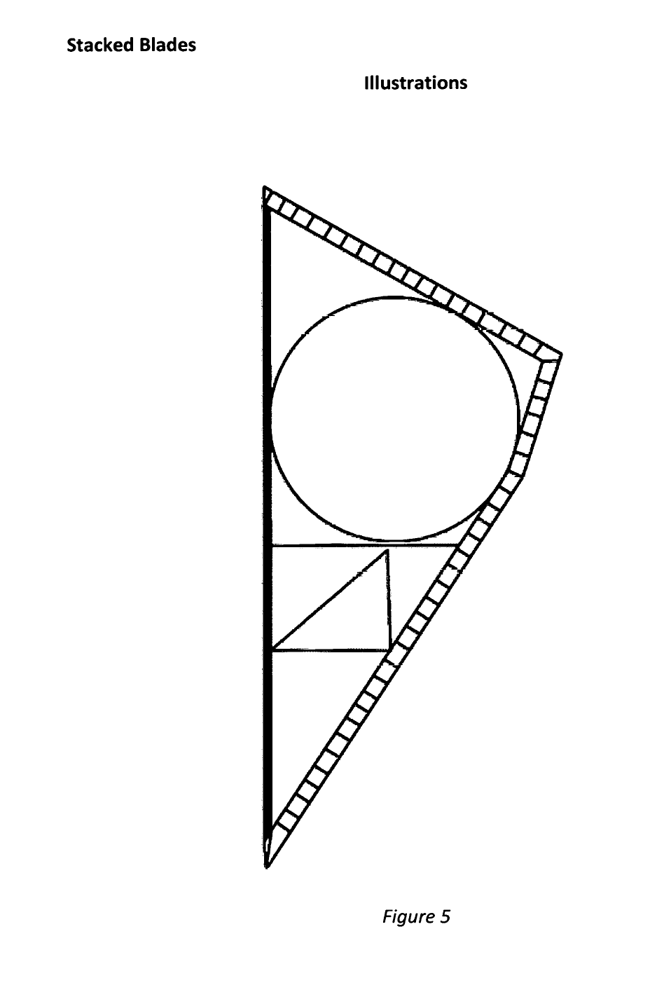

Blade: Another object of this invention is to capture the most spillover wind or fluid flow as possible and retard loss off the end of the blade. The blade (FIG. 1) is designed to overlap the entire length of the blade with the blade in front or behind. It is generally triangular in shape and has a “lip” across the top (FIG. 1) for the purpose of holding wind or fluid flow on that blade's surface and direct the flow off the long edge of the blade onto the next blade and retard it from flowing off the end of the blade. This way more spillover will impact the trailing blade. This permits the capture of the calculus of the spillover, much as a funnel captures spillover from an outer ring to the next ring ^{dy}/_{dx} distance in a high pressure hose. There are no limits concerning the number of blades as long as they are in balance around the hub or shaft, just as there are no limits to increasing the pressure in water from a hose to water pick. The edge of the blade is not rounded (FIGS. 4 and 5), but the long edge of the blade is straight so the blade can still capture the rotational effect of high winds even when rotated 90°. The angle of the long edge (FIGS. 4 and 5) may vary based on the number of total blades in use on a particular application.

Methane Jets or rockets: Another object of this invention is to utilize the physics that “for every action there is an equal and opposite reaction” in low or no wind conditions to keep the windmill operating between the optimum rpms. For example, if the wind slows and the rpms drop from 100 rpms to 80 rpms, then the methane jets or rockets will fire until the rpms increase to 90 rpms. If the rpms again drop to 80 rpms, the methane jets or rockets will again fire to bring the rpms back to 90 rpms. This cycle would continue until wind speeds become adequate to again fully operate the windmill between 80 and 100 rpms.

Wind or No-Wind Operation: Another object of this invention is to make this windmill or watermill operational between optimum rpms with or without wind. The object of this invention is the effect of all the components interacting and the way these components complement each other to create reliable 24/7 operation without batteries. It would also be operational under very adverse conditions like hurricane force winds or severe flooding. Such control over rpms in wind or slow fluid flow has never been possible before.

Flexibility: Stacked Blade Windmill is flexible in that it may be utilized with 2 blade sets, 3 blade sets, or as many blade sets as desired for a particular application. It is flexible in its ability to be scalable. It may be miniaturized as well as applied to large 100 foot tall windmills or tidal watermills. It is flexible in that it can be used in wind or in slower flowing fluids such as rivers or streams. In rivers and streams, there is no limit to the number of blades stacked and may increase collected energy by well over the 400% model tests that used 6 blades. In extremely slow flowing conditions 100 blades or more could be stacked to increase the pressure of flow where in air there are practical limitations to the number of blades stacked to fewer than 10. It is also flexible in that the stacked blades may be utilized without the methane jets or rockets such as in river or tidal applications and some air applications. Another way this is flexible is the methane jets or rockets may be utilized without any wind blades such as on captured methane from a landfill or other high concentrations of methane gas like from farm animal septic systems. The pollution in landfill methane would exhaust out the back of jets or rockets with no harm.

Un-Stacked Blades: It is another object of this invention to provide control of rpms in a way never done before. Blades have always turned 90° to the wind and the angle “feathered” to maintain operation, but mainly to protect the windmill from damage. Because these blades are stacked, they can be unstacked from back to front as wind increases. For example, if 100 rpms is peak efficiency, then when the rpms reach 100 rpm, the back blade turns 90° to the wind or fluid and the rpm reduces to 85 rpm. If the rpm again reaches 100 rpm, the next to back blade turns 90° to the wind or fluid flow and again the rpms reduce to 85 rpm. This continues until all blades have turned 90° to the wind or fluid flow. The edge of each blade is also a high wind blade. (FIGS. 4 and 5)

Additional Information: In theory, a stacked blade set does not have a limit on the number of blades in a blade set. Just as in a hydrology high pressure funnel, there is no limit on the number of ^{dy}/_{dx} slices there may be and the smaller the opening, the higher the pressure. Likewise, the more blades in a blade set, the more turbulence that can be collected and thus power generated (FIG. 10).

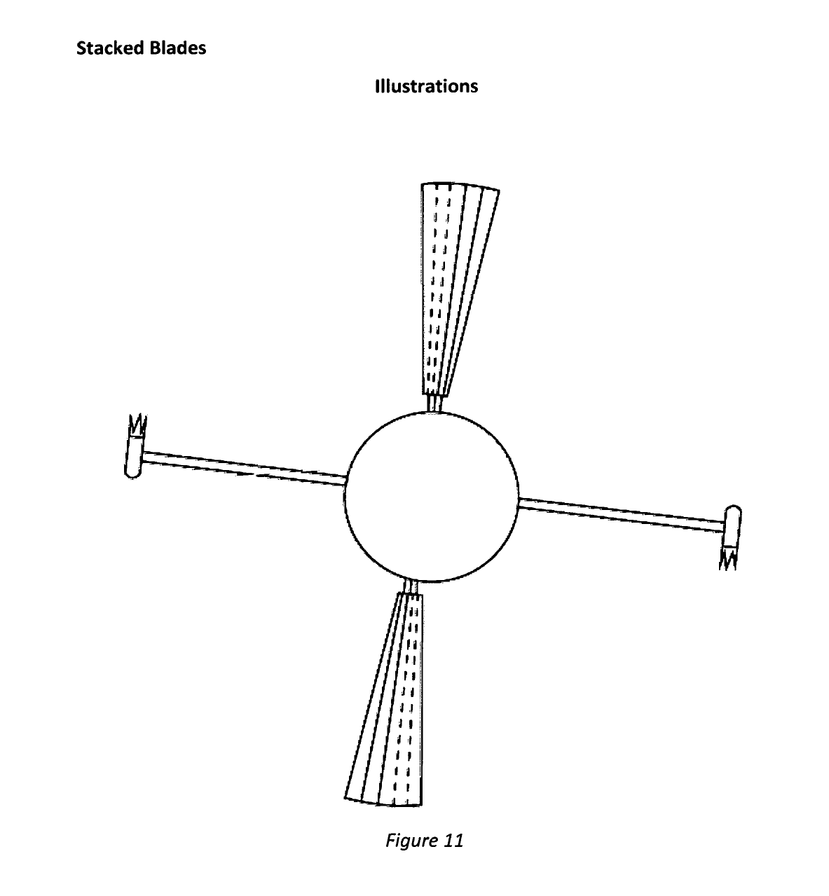

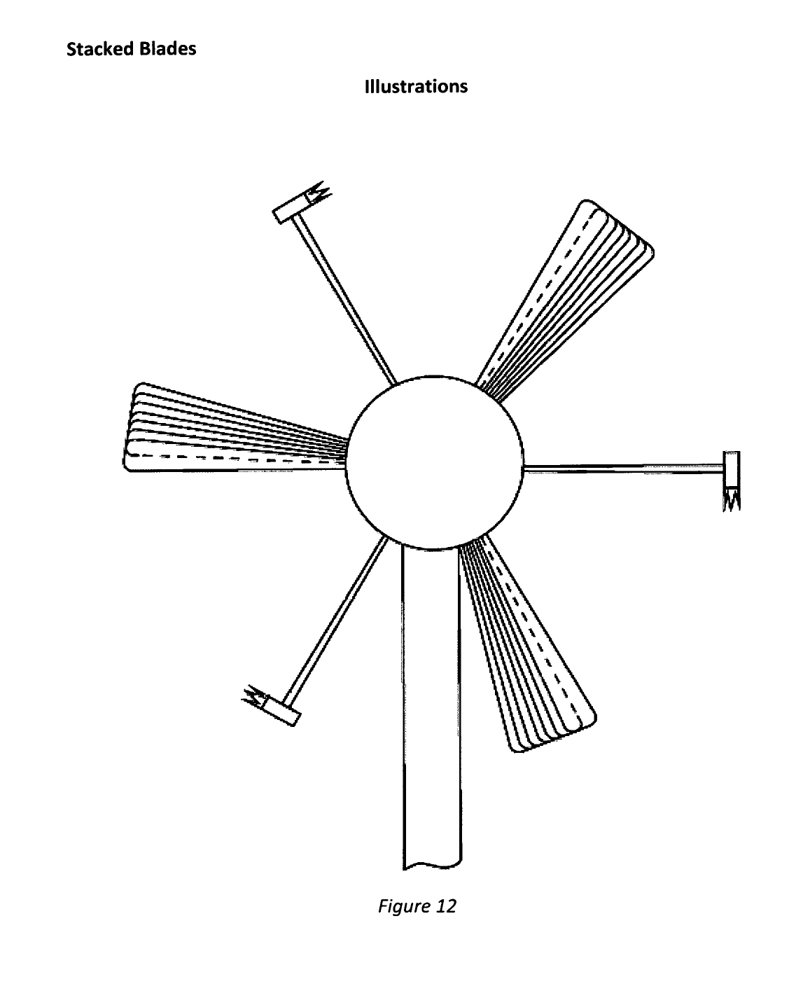

There are also no limits to the number of blade sets around the hub except that they must be balanced around the hub. For example there could be two blade sets (FIG. 11) or three blade sets (FIG. 12)

### ILLUSTRATIONS

FIG. 1 Three views of one blade

FIG. 2 Front view of stacked Blades (No visible spaces between blades)

FIG. 3 Front view of normal blade distribution
(Spaces visible—NOT Stacked blades)

FIG. 4 Cutaway of one blade (Horizontal orientation)

FIG. 5 Cutaway of one blade (Vertical orientation)

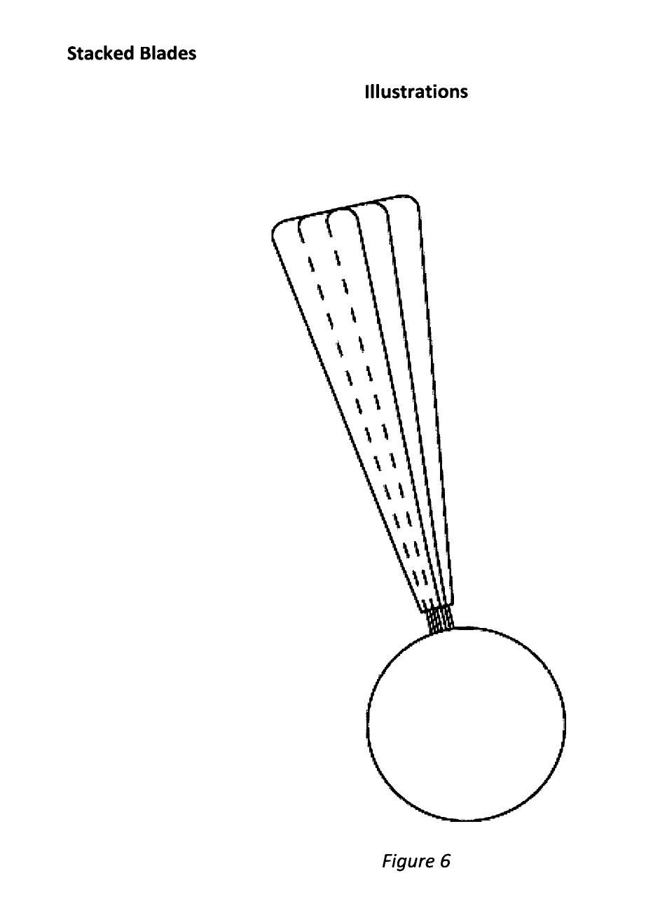

FIG. 6 Example of three blades “collecting” the wind

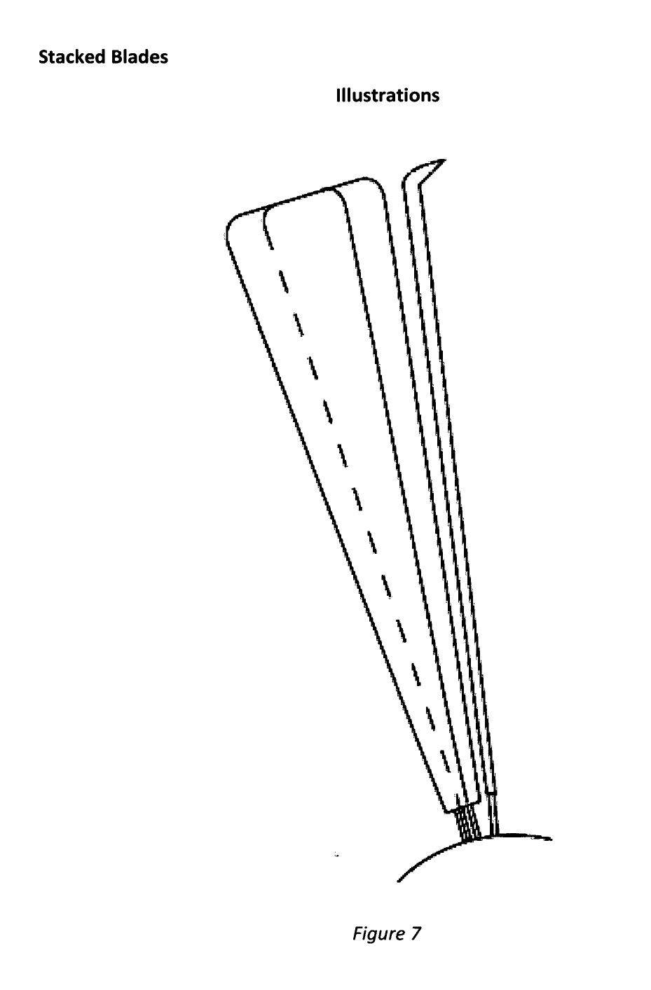

FIG. 7 Example of three blades with one not collecting wind

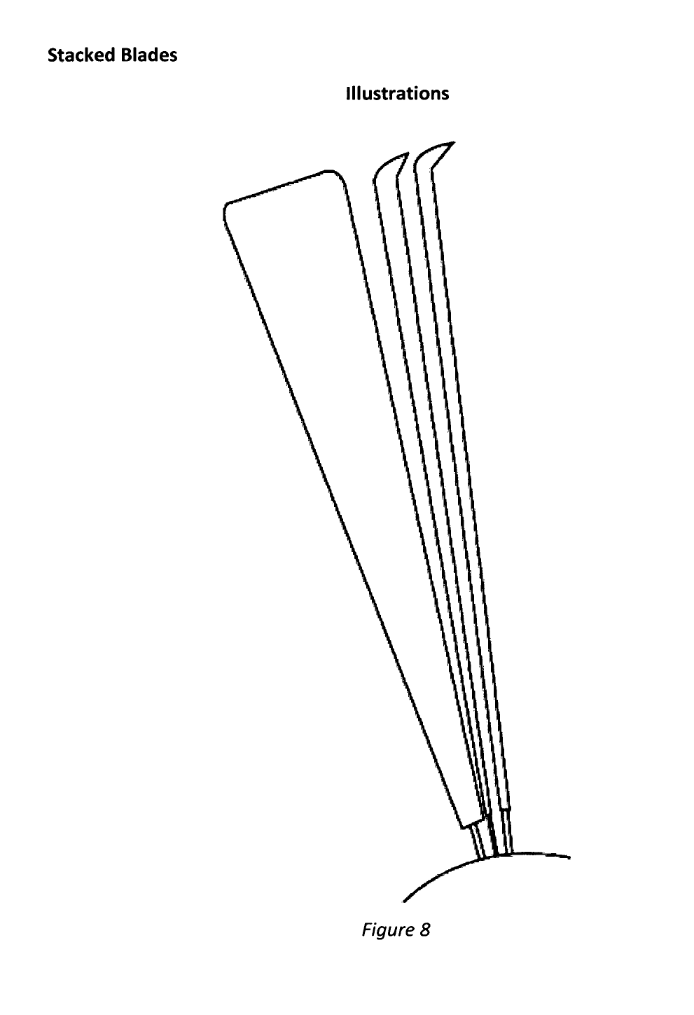

FIG. 8 Example of three blades with two not collecting wind

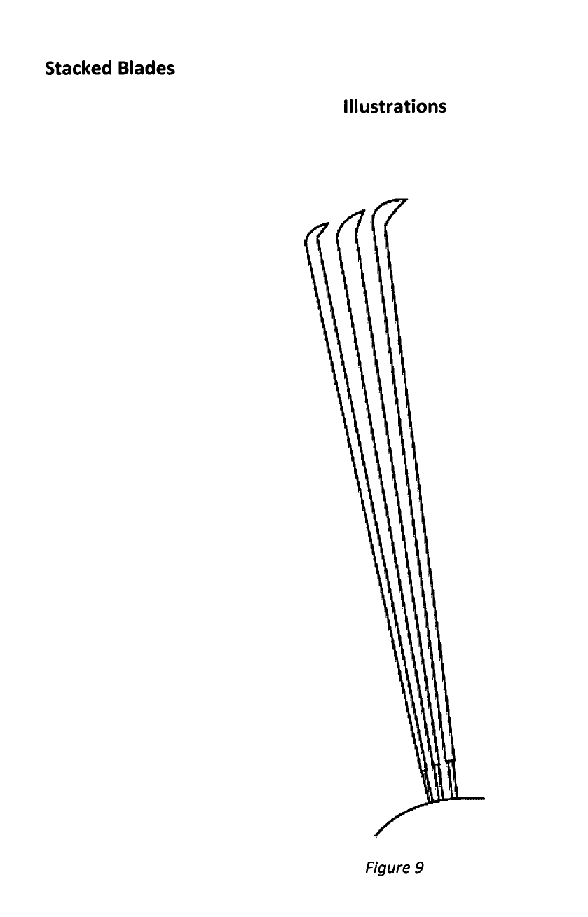

FIG. 9 Example of three blades with none collecting wind

FIG. 10 Illustration of many (no theoretical limit) on blade number

FIG. 11 Illustration of two blade sets and two rockets/jets

FIG. 12 Illustration of three blade sets with three rockets/jets

1. stacked blades operating in flowing fluid, the harnessing of turbulence, unstacking blades, jets/rockets assisting windmill operation to maintain wind operation in low or no wind conditions, and overall maintaining fairly consistent rpms creating 80% to 100% efficiency during windmill operation 24/7 with 10
